(19) United States
(12) Patent Application Publication
(10) Pub. No.: US 2024/0351251 A1
(43) Pub. Date: Oct. 24, 2024

(54) FABRICATION OF REFLECTIVE POLYMER WAVEGUIDE MOLD

(71) Applicant: GOOGLE LLC, Mountain View, CA (US)

(72) Inventors: Kang Luo, San Jose, CA (US); Thomas Mercier, Weston, FL (US); Christophe Peroz, Zollikon (CH)

(21) Appl. No.: 18/640,071

(22) Filed: Apr. 19, 2024

Related U.S. Application Data
(60) Provisional application No. 63/460,712, filed on Apr. 20, 2023.

(51) Int. Cl. B29C 33/38; B29D 11/00

(52) U.S. Cl. CPC B29C 33/3842; B29D 11/00663

(57) ABSTRACT

Techniques for fabricating a polymer reflective waveguide mold with high structural quality control (flatness, alignment, dimensions) and high precision and groove parallelism for high optical quality include using optical lithography and wet etch process. For example, a method of fabricating a reflective waveguide mold includes depositing a hard mask layer on a crystalline substrate, lithographically patterning the hard mask layer, and anisotropically removing the crystalline substrate to form a prism array waveguide mold.

### BACKGROUND

Reflective waveguides can enable high efficiency, uniform augmented reality display with limited artifacts (low eye glow, low rainbow, etc.). Current polymer reflective waveguide fabrication processes use a pressure molding process to fabricate separate prism arrays using thermoplastic material in a mold. The mold may include prism facets which are fabricated by diamond turning machining. However, the diamond turning machining results in surface roughness and non-parallelism of the mold facets that may not meet the ultra-high flatness and parallelism requirements for waveguide components of augmented reality displays

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating a rear perspective view of an augmented reality display device implementing reflective waveguide portions manufactured using a crystalline mold structure in accordance with some embodiments.

FIG. 2 is a diagram illustrating a cross-section view of an example implementation of a waveguide in accordance with some embodiments.

FIG. 3 is a diagram illustrating a reflective waveguide with two-dimensional pupil expansion geometry.

FIG. 4 is a diagram illustrating surface roughness and non-parallelism of a mold manufactured using diamond turning machining.

FIGS. 5A-F illustrate a mold fabrication flow in accordance with some embodiments.

FIGS. 6A-D illustrate examples of the fabrication of a prism array with perfect alignment and with misalignment between the lithographic patterns and the crystalline axis of the substrate.

FIGS. 7A-B illustrate an example of a prism array fabricated using potassium hydroxide (KOH) to wet etch a Si substrate in accordance with some embodiments.

FIGS. 8A-C illustrate various types of periodic structures with varying geometries achievable based on the crystal orientation of the substrate in accordance with some embodiments.

FIGS. 9A-D illustrate a process flow for modifying an angle of the prism or other structures either symmetrically or asymmetrically by resist shrinkage in accordance with some embodiments.

FIGS. 10A-F illustrate a process flow for modifying the angle of the prism or other structures by plasma etching in accordance with some embodiments.

FIGS. 11A-F illustrate a double patterning and etch process of fabricating a two-dimensional prism in accordance with some embodiments.

FIGS. 12A-D illustrate a process flow for fabricating two-dimensional reflective structures using a double-imprint process in accordance with some embodiments.

FIGS. 13A-D illustrate a double-imprint process for integrating arrays having different structures together in accordance with some embodiments.

FIGS. 14A-D illustrate a micro-imprint and etch process for fabricating a composite mold in accordance with some embodiments.

### DETAILED DESCRIPTION

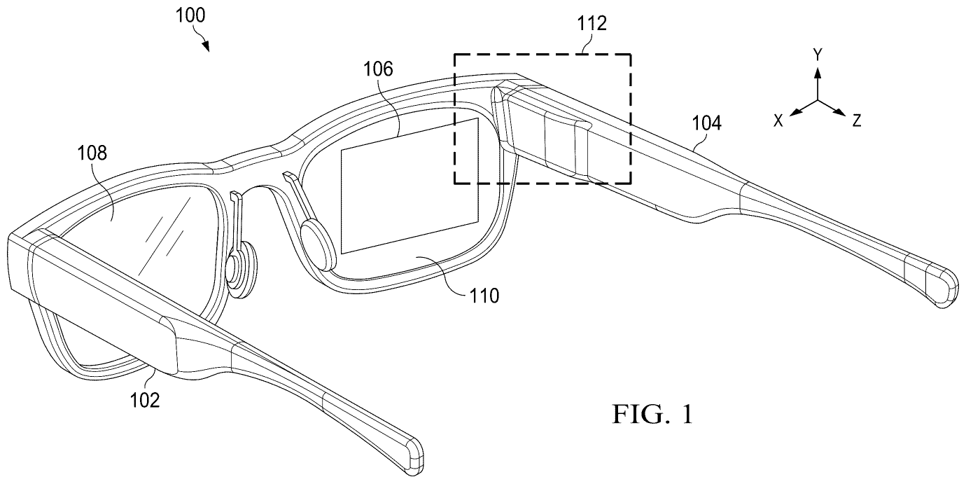

In order to fabricate a mold for forming portions of the reflective polymer waveguide, conventional techniques such as diamond turning machining yield molds that fail to meet flatness and parallelism requirements. By contrast, FIGS. 1-14 illustrate techniques for fabricating a polymer reflective waveguide mold with high structural quality control over parameters such as flatness, alignment, and dimensions, with high precision and groove parallelism for high optical quality by using an optical lithography and wet etch process. The techniques described herein use the crystal axis of a substrate to define periodic structures with high parallelism, pitch, and flatness accuracy, including for grooves with varying height.

FIG. 1 illustrates an example AR eyewear display system 100 implementing a reflective waveguide formed by casting portions of the waveguide to each other without an adhesive layer in accordance with some embodiments. The AR eyewear display system 100 includes a support structure 102 (e.g., a support frame) to mount to a head of a user and that includes an arm 104 that houses a laser projection system, micro-display (e.g., micro-light emitting diode (LED) display), or other light engine configured to project display light representative of images toward the eye of a user, such that the user perceives the projected display light as a sequence of images displayed in a field of view (FOV) area 106 at one or both of lens elements 108, 110 supported by the support structure 102. In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like.

The support structure 102 further can include one or more batteries or other portable power sources for supplying power to the electrical components of the AR eyewear display system 100. In some embodiments, some or all of these components of the AR eyewear display system 100 are fully or partially contained within an inner volume of support structure 102, such as within the arm 104 in region 112 of the support structure 102. In the illustrated implementation, the AR eyewear display system 100 utilizes an eyeglasses form factor. However, the AR eyewear display system 100 is not limited to this form factor and thus may have a different shape and appearance from the eyeglasses frame depicted in FIG. 1.

One or both of the lens elements 108, 110 are used by the AR eyewear display system 100 to provide an AR display in which rendered graphical content can be superimposed over or otherwise provided in conjunction with a real-world view as perceived by the user through the lens elements 108, 110. For example, laser light or other display light is used to form a perceptible image or series of images that are projected onto the eye of the user via one or more optical elements, including a waveguide, formed at least partially in the corresponding lens element. One or both of the lens elements 108, 110 thus includes at least a portion of a waveguide that routes display light received by an incoupler (IC) (not shown in FIG. 1) of the waveguide to an outcoupler (OC) (not shown in FIG. 1) of the waveguide, which outputs the display light toward an eye of a user of the AR eyewear display system 100. Additionally, the waveguide employs an exit pupil expander (EPE) (not shown in FIG. 1) in the light path between the IC and OC, or in combination with the OC, in order to increase the dimensions of the display exit pupil. Each of the lens elements 108, 110 is sufficiently transparent to allow a user to see through the lens elements to provide a field of view of the user's real-world environment such that the image appears superimposed over at least a portion of the real-world environment.

To allow for a smaller, more compact form-factor, in some embodiments, one or more of the IC, OC, and/or EPE use reflective waveguide facets either to reflect light from one surface of the waveguide back to the same surface or to allow light to travel through the facets from one surface of the waveguide to a different, opposing surface of the waveguide. Such reflective waveguide facets must be ultra flat and smooth, with extremely tight alignment to meet specifications for optical performance. Polymer reflective waveguides are pressure molded using a mold with corresponding ultra flat facets that is fabricated using the techniques described herein in some embodiments.

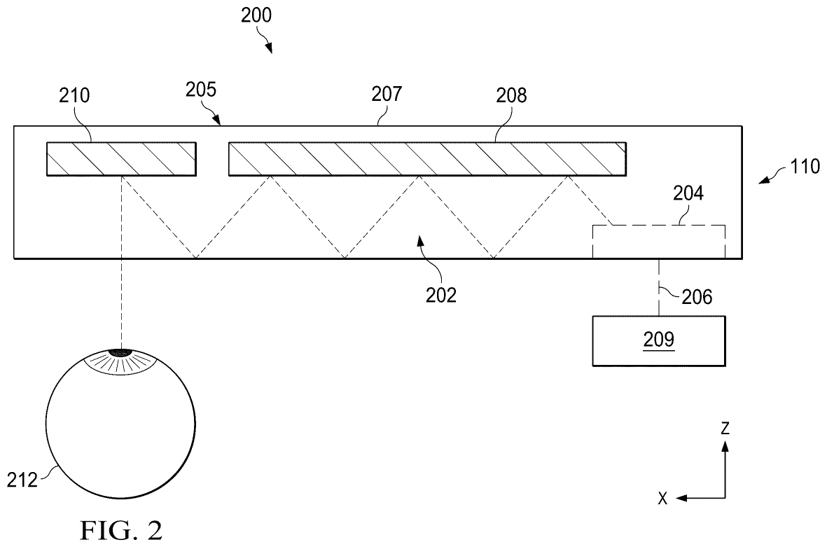

FIG. 2 depicts a cross-section view of an implementation of a display system 200 partially included in a lens element such as lens element 110 of an AR eyewear display system such as AR eyewear display system 100, which in some embodiments comprises a waveguide 202. Note that for purposes of illustration, at least some dimensions in the Z direction are exaggerated for improved visibility of the represented aspects.

The waveguide 202 includes an incoupler 204 and an outcoupler 210. The term “waveguide,” as used herein, will be understood to mean a combiner using one or more of total internal reflection (TIR), specialized filters, and/or reflective surfaces, to transfer light from an incoupler (such as the incoupler 204) to an outcoupler (such as the outcoupler 210). In some display applications, the light is a collimated image, and the waveguide transfers and replicates the collimated image to the eye. In general, an incoupler and outcoupler each include, for example, one or more optical grating structures, including, but not limited to, reflective gratings, diffraction gratings, holograms, holographic optical elements (e.g., optical elements using one or more holograms), volume diffraction gratings, volume holograms, surface relief diffraction gratings, and/or surface relief holograms. In some embodiments, a given incoupler or outcoupler is a reflective grating (e.g., a reflective diffraction grating or a reflective holographic grating) that causes the incoupler or outcoupler to reflect light and to apply designed optical function(s) to the light during the reflection.

In the present example, the display light 206 received at the incoupler 204 is relayed to the outcoupler 210 via the waveguide 202 using TIR. The display light 206 is then output to the eye 212 of a user via the outcoupler 210. As described above, in some embodiments the waveguide 202 is implemented as part of an eyeglass lens, such as the lens 108 or lens 110 (FIG. 1) of the display system having an eyeglass form factor and employing the display system 200.

In this example implementation, the waveguide 202 implements facets in the region 208 (which provide exit pupil expansion functionality) and facets of the region 210 (which provide OC functionality) toward the world-facing side 207 of the waveguide 202 and the lens element 110, and the facets of the IC 204 are implemented toward the eye-facing side 205 of the lens element 110. Thus, under this approach, display light 206 from a light source 209 is incoupled to the waveguide 202 via the IC 204, and propagated (through total internal reflection in this example) toward the region 208, whereupon the facets of the region 208 reflect the incident display light for exit pupil expansion purposes, and the resulting light is propagated to the facets of the region 210, which output the display light toward a user's eye 212. In other embodiments, the facets of the IC 204 are implemented toward the world-facing side 207 of the lens element 110.

Embodiments of reflective waveguide structures formed according to the techniques described herein achieve uniform display quality with limited artifacts using reflective waveguide facets, as described further hereinbelow. For example, in some embodiments, the facets allow display light to travel through the facets from one surface of the waveguide to a different, opposing surface of the waveguide rather than, e.g., reflecting the light from one surface back onto the same surface. In some embodiments, as described further hereinbelow, the facets are formed to have a desired shape that enables this functionality using a mold that is formed using optical lithography and a wet etch process on a crystalline substrate.

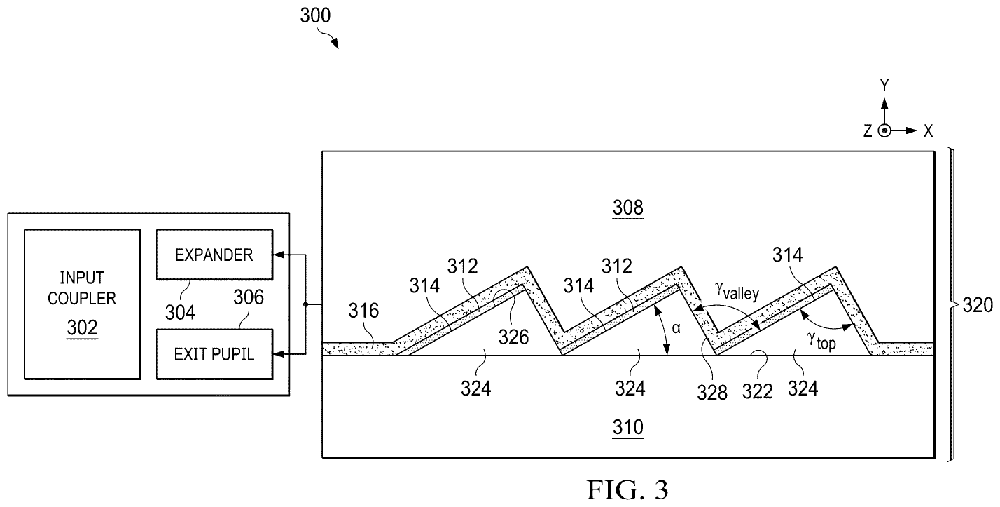

In some embodiments, a reflective waveguide consists of different areas depicted in FIG. 3, which illustrates a schematic diagram of a reflective waveguide 300 with two-dimensional pupil expansion geometry. The reflective waveguide 300 includes an incoupler 302 and an expander area 304 and exit pupil area 306 that utilize a specific prism array 320 with specific orientation and pitch. In some embodiments, the prism array 320 has variable height. In some embodiments, the surface of the prism is ultra flat and smooth, and the alignment is extremely tight. Current reflective waveguide eyepieces are typically fabricated by injection molding and limited to one-dimensional (1D) pupil expansion. The use of two-dimensional (2D) pupil expansion geometry carries even more stringent specifications for flatness, parallelism, and roughness, etc. These tighter specifications make the fabrication of the mold by diamond turning machine (or other mechanical methods) even more challenging, and at the limits of its resolution.

For example, the prism array 320 includes a top prism array 308 and a bottom prism array 310. The top prism array 308 and bottom prism array 310 are fabricated separately by injection molding. The bottom prism array 310 is characterized by a top surface 322 on which a series of prism structures 324 are formed. Each of the prism structures 324 includes a primary surface 326 and a secondary surface 328. The primary surface 326 is disposed at an angle α with respect to the top surface 322 and at an angle γₜₒₚ with respect to the secondary surface of the prism structure 324. The primary surface 326 is disposed at an angle γ_{valley} with respect to the previous secondary surface 328 in the series. One or more reflective coatings 312 is selectively deposited on the facets 314 of the bottom prism array 310. In some cases, a precision bonding process using, e.g., a polymer glue 316 is then carried out to form the final waveguide.

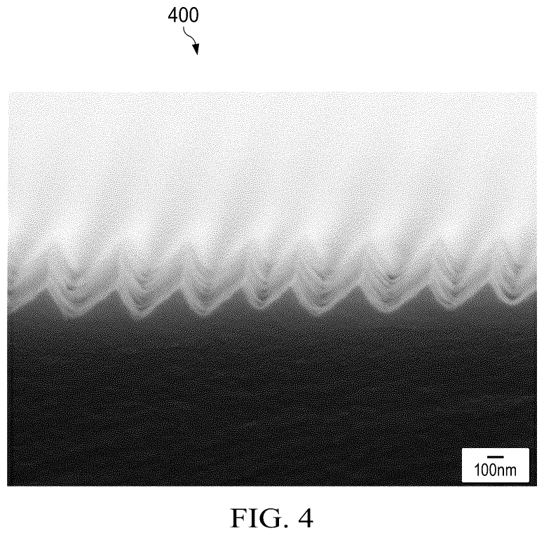

FIG. 4 illustrates an example of a prism fabricated using a diamond turning machine (DTM). The DTM-fabricated prism shows surface roughness and non-parallelism that can negatively impact the efficiency and optical performance of a reflective waveguide implementing the prism.

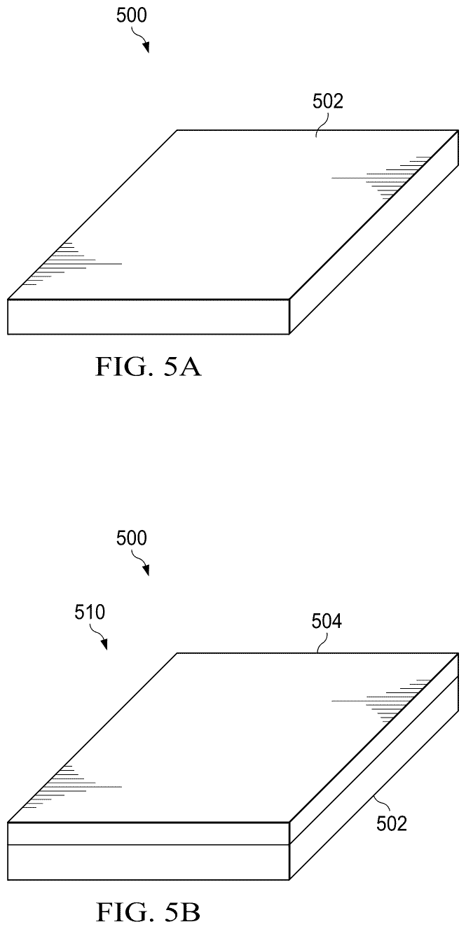

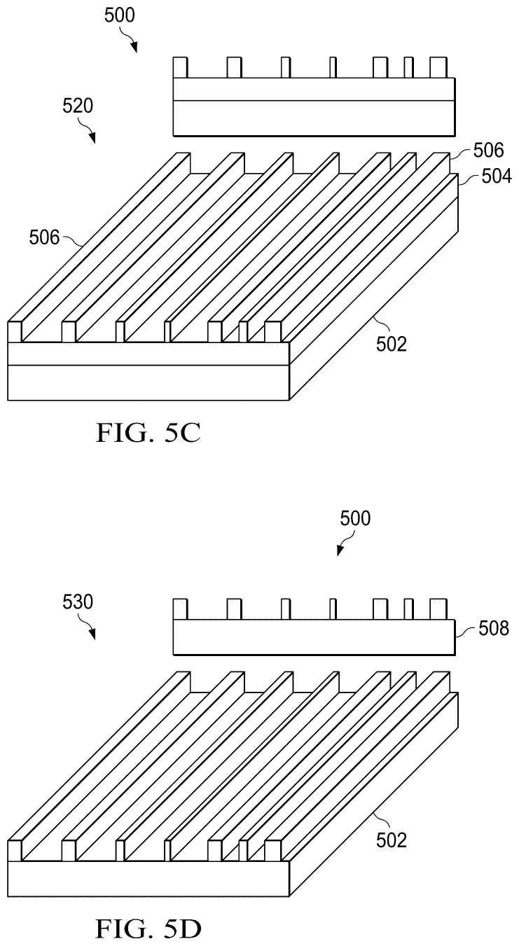

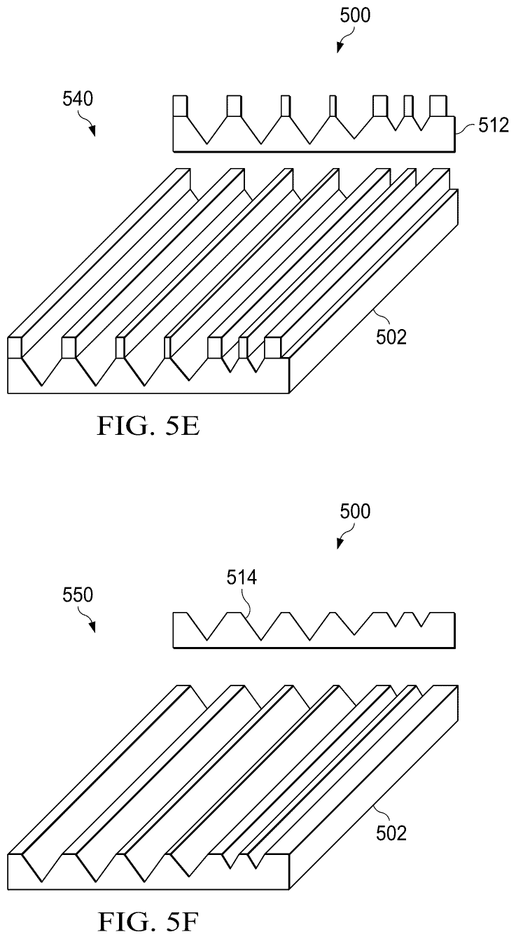

FIGS. 5A-F illustrates a fabrication process 500 for fabricating a prism array by wet etching of a crystalline substrate in accordance with some embodiments. In some embodiments, the fabrication process uses the crystal axis of substrate to define periodic optical structures with high parallelism, pitch and flatness accuracy.

The process starts, as shown in FIG. 5A, with a crystalline substrate 502 that can be silicon, LiNbO3 or other crystal material. At step 510, hard mask layer 504 is deposited that can be SiO2, SiN, metals or others, as shown in FIG. 5B. At step 520, a lithography process that is used to imprint a pattern from a lithography resist 506 to the hard mask layer 504, as shown in FIG. 5C. In some embodiments, the lithography process involves lithography exposure, development and pattern transfer from the lithography resist 506 to the material of the hard mask layer 504. The lithography process can be e-beam lithography, photo lithography, nanoimprint lithography, direct laser writing or any other lithography processes. A wet chemical etching process such as that shown at steps 530, 540 in FIGS. 5D and 5E, is followed to anisotropically remove the substrate material 502, leaving the hard mask layer with the imprinted pattern 508, shown in cross-section in FIG. 5D. Removal of the substrate material 502 continues at step 540, shown in FIG. 5E, resulting in prism structures 512 being etched under below the hard mask layer 504. The anisotropic removal process will self-terminate at step 550, as shown in FIG. 5F, at certain crystalline planes of the substrate and define polygon structures 514 (prism or other) with atomic level smoothness, flatness and parallelism which are periodically repeated.

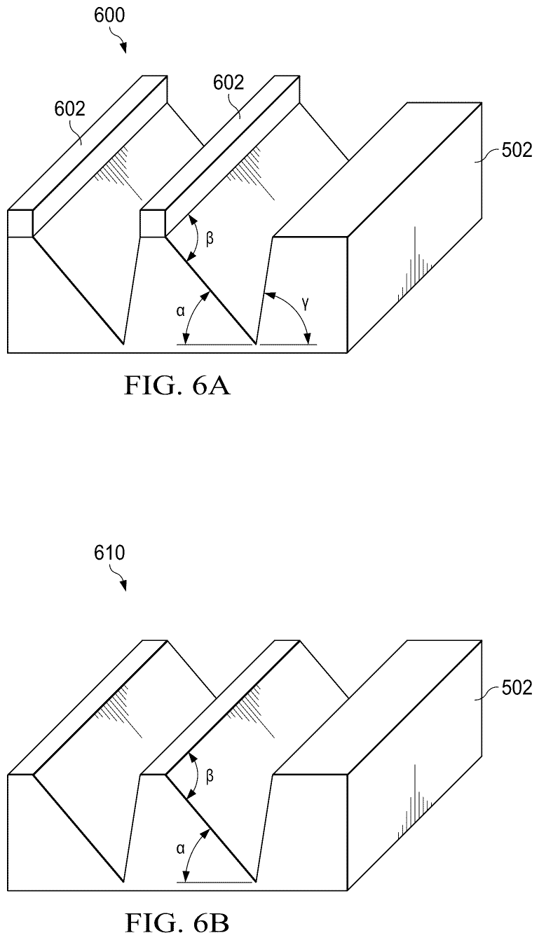

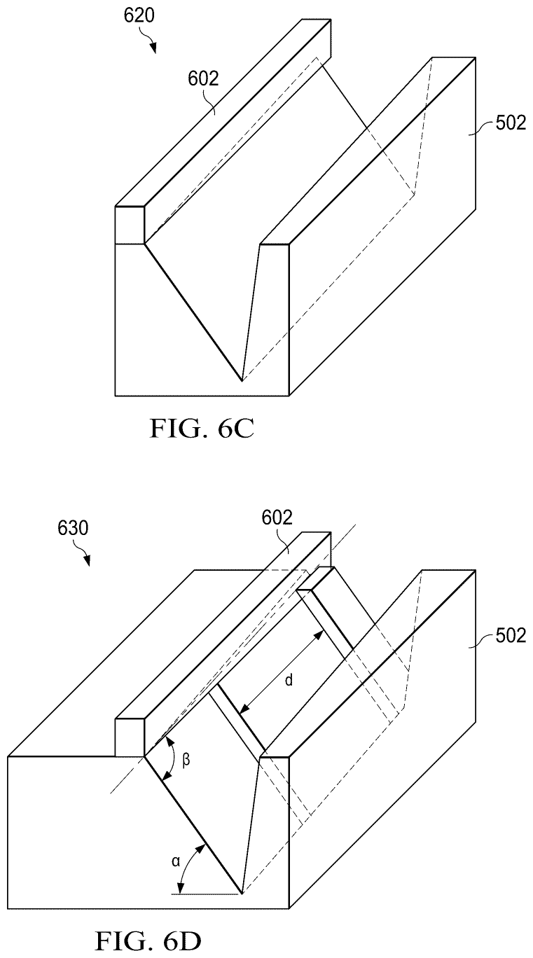

FIGS. 6A-D illustrate examples of the fabrication of a prism array with perfect alignment (examples 600, 610 in FIGS. 6A and 6B, respectively) and with misalignment (examples 620, 630 in FIGS. 6C and 6D, respectively) between the lithographic patterns and the crystalline axis of the substrate. Examples 600, 610 illustrate an ideal situation with the lithography-defined hard mask pattern 602 aligned with the crystal axis of the substrate 502. Angle α or γ measures the direction of the reflective plane itself. This angle is determined by the crystal axis. Using this approach, the alignment between the structures/prisms is kept very high (e.g., on the order of Δα<10⁻⁶ degrees), resulting in unmatched image quality compared to the conventional approach where the alignment is limited by the precision of mold machining such as diamond turning molding with alignment between the structures/prisms on the order of Δα>10⁻³ degrees. Angle β measures how the reflective planes are aligned to the desired direction of the crystal axis of the substrate and among each other. This angle is related to both the crystal axis and lithography.

Examples 620, 630 show a configuration where the hard mask grating 602 is misaligned to the crystal axis of the substrate 502. After the wet etching step, step “terrace” structures will be developed. Each terrace will follow the same crystal axis and maintain the same α, γ angles of the reflective structure, but the steps will be observed to diverge from the crystal axis of the substrate 502. The distance d between each step is determined by the angle β between the hard mask grating 602 and the crystal axis of the substrate 502. This distance d could vary between several hundred nanometers up to several millimeters. For example, if the hard mask grating 602 is misaligned by 10 nanometers over 100 mm distance versus the crystal axis of the substrate 502, this corresponds to the parallelism of β=arctan (10 nm/100 mm)=5×10⁻⁶ degrees.

This misalignment between the lithographic pattern and the crystal plane corresponds to a thickness variation of the facet of the prism in the z direction. This PV flatness is usually very difficult to control due to DTM and other techniques and is typically around 500 nm/cm.

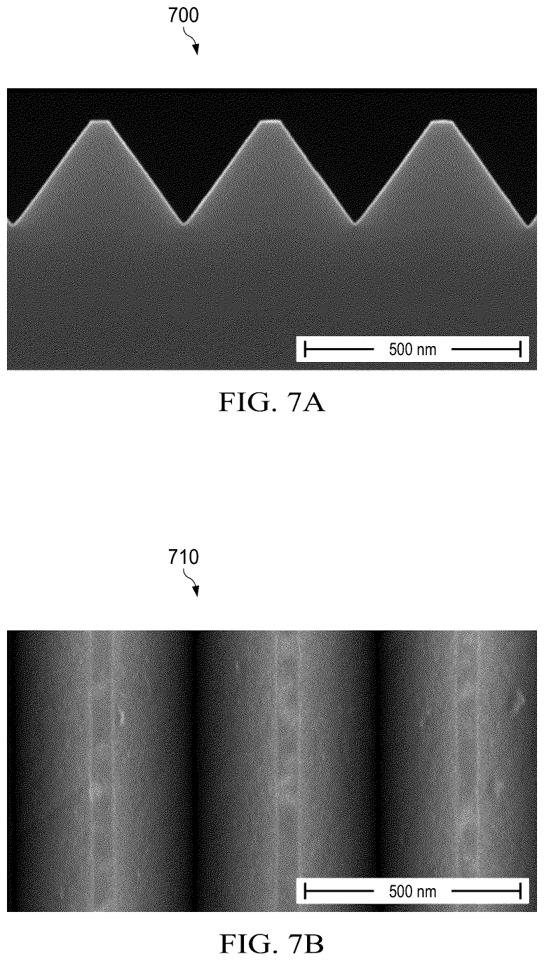

FIGS. 7A-B show an example of using potassium hydroxide (KOH) to wet etch a silicon (Si) substrate and result in the final perfect prism array. A cross section scanning electron microscope (SEM) image 700 of the prism array is shown in FIG. 7A, and a top-down SEM image 710 of the prism array is shown in FIG. 7B. FIGS. 7A and 7B illustrate the ultra-flatness of the prism facets that result from wet etching along the crystal axis of the substrate 502.

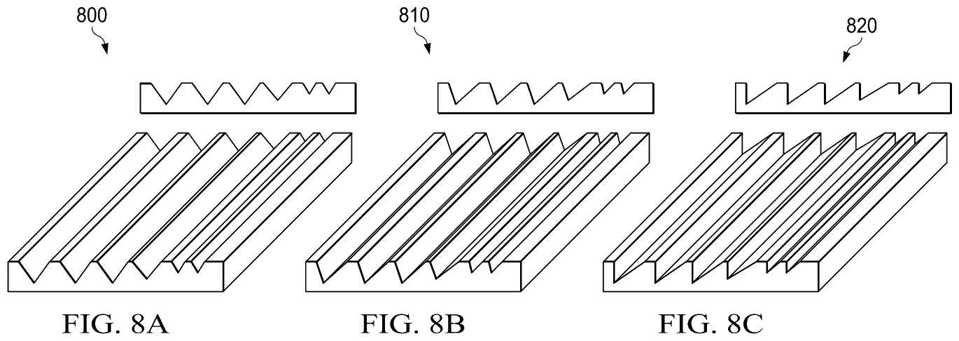

The crystal orientation of the substrate can be chosen so that the periodic structures/grooves of the array can have various geometries, as shown in FIGS. 8A-C. Prism array 800 shown in FIG. 8A has symmetric grooves determined by crystalline axes of the substrate. Prism array 810 shown in FIG. 8B has asymmetric grooves determined by a different set of crystalline axes of the substrate. Prism array 820 shown in FIG. 8C has asymmetric grooves with one vertical side, formed by wet etching the crystalline substrate along selected crystalline axes. The height hₚ of the structures is determined by the pitch and the flat top width of the lithographic patterns. Both the pitch and the flat top width are defined by the lithography process. They can vary from several nanometers to several centimeters with the accuracy of a few nanometers. By changing the pitch and top flat width, the structures (i.e., prisms) of the array can have various heights, which can be beneficial to increase the overall brightness and uniformity of the AR display. The radius of curvature γ_{valley} (shown in FIG. 3) in the valley of the prism is determined by the intersection of two crystalline planes and can be as sharp as a few atoms, as shown in FIG. 7.

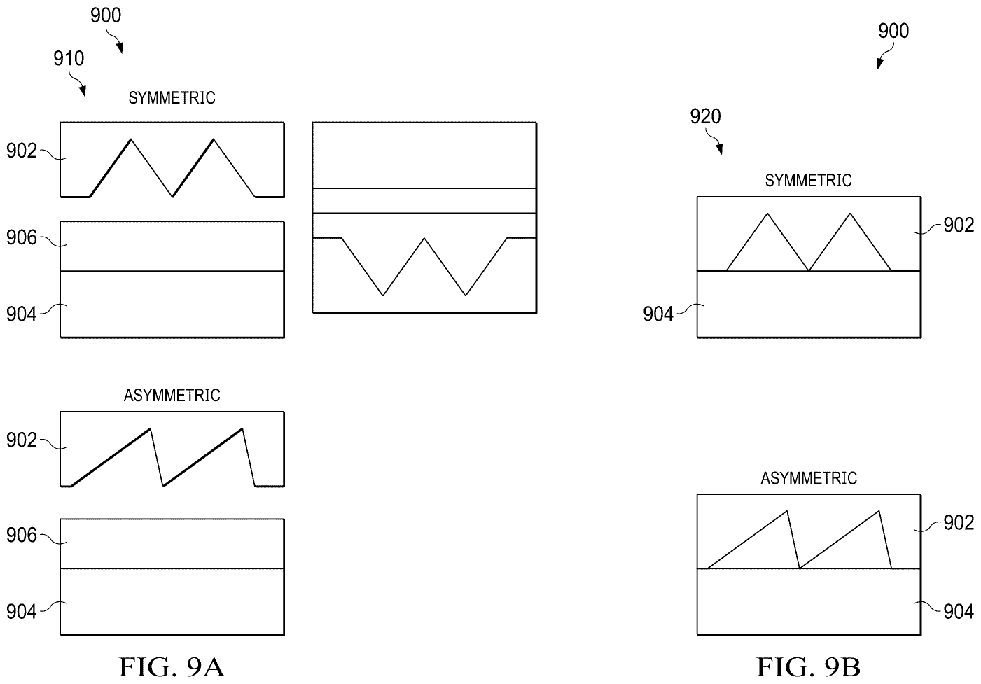

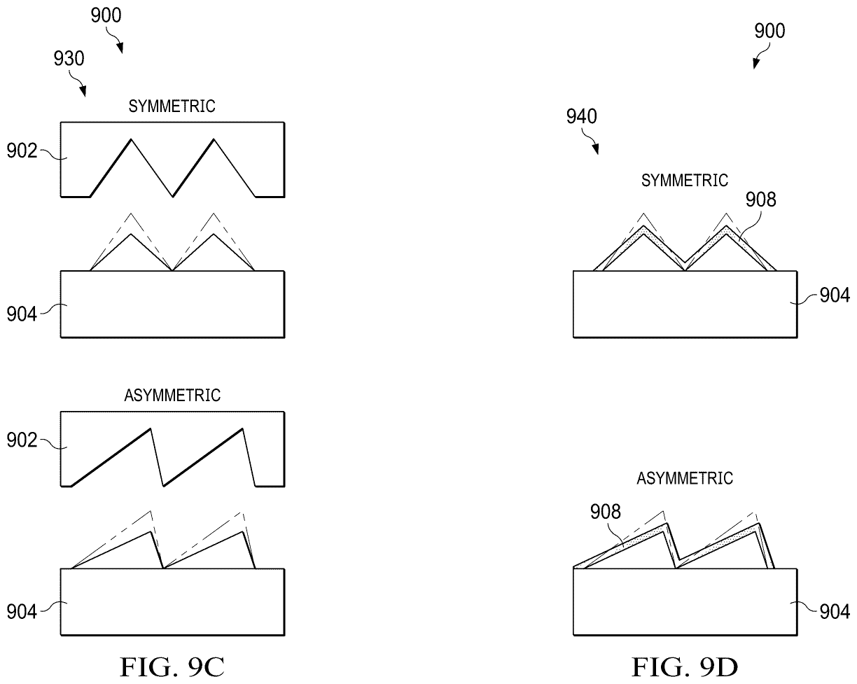

The prism shape can be further tuned by the post-fabrication process. One process flow 900 for modifying an angle of the prism or other structures either symmetrically or asymmetrically by resist shrinkage is depicted in FIGS. 9A-D. The process starts in some embodiments as shown in FIG. 9A at step 910 with a pre-fabricated mold 902 from the previous wet etch process such as the fabrication process 500 of FIG. 5. The pattern is replicated by a micro-imprint process at step 920 on an optical substrate 904 with a functional resin 906, as shown in FIG. 9B. The functional resin 906 is first coated on either the optical substrate 904 or the pre-fabricated mold 902 to obtain a faithful mold filling/replication. The resin can be solidified by either UV curing or heating or a combination. After separating the resin replica from the initial mold, at step 930, the resin could be shrunken by itself or any other treatment, such as heat, flood UV exposure, or a combination of both, as shown in FIG. 9C. The shrinkage could lead to reduction of the prism angle determined by the shrinkage ratio. Most resin can shrink from 0.1% up to 20% (better 2% to 10%) and corresponds to the prism angle change from 1% to ˜10%. An anti-sticking layer 908 is then deposited on the resin mold at step 940 to minimize the friction during the prism fabrication process, as shown in FIG. 9D. The anti-sticking layer 908 can be either organic or inorganic material.

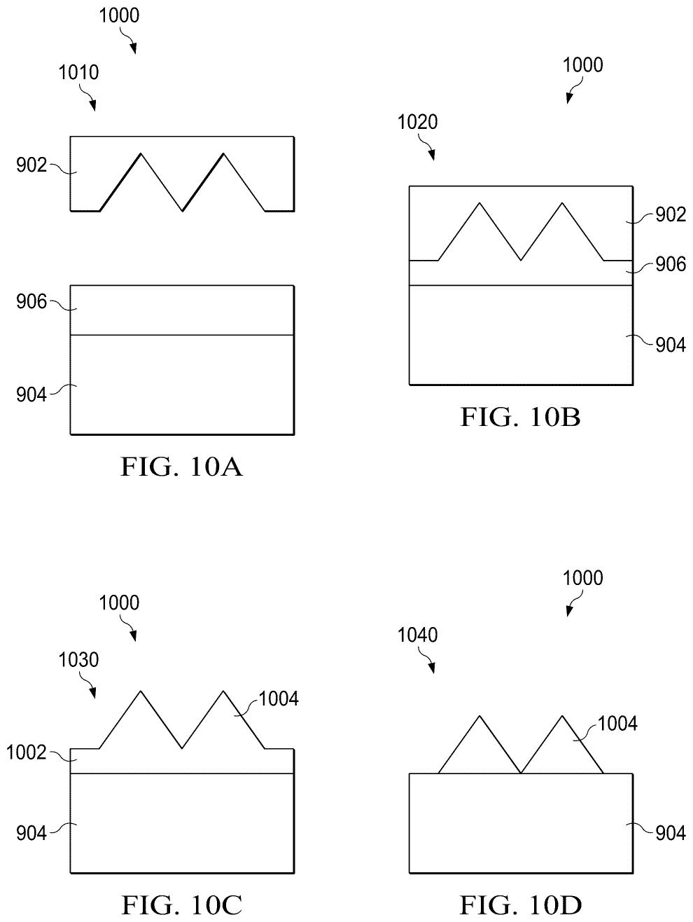

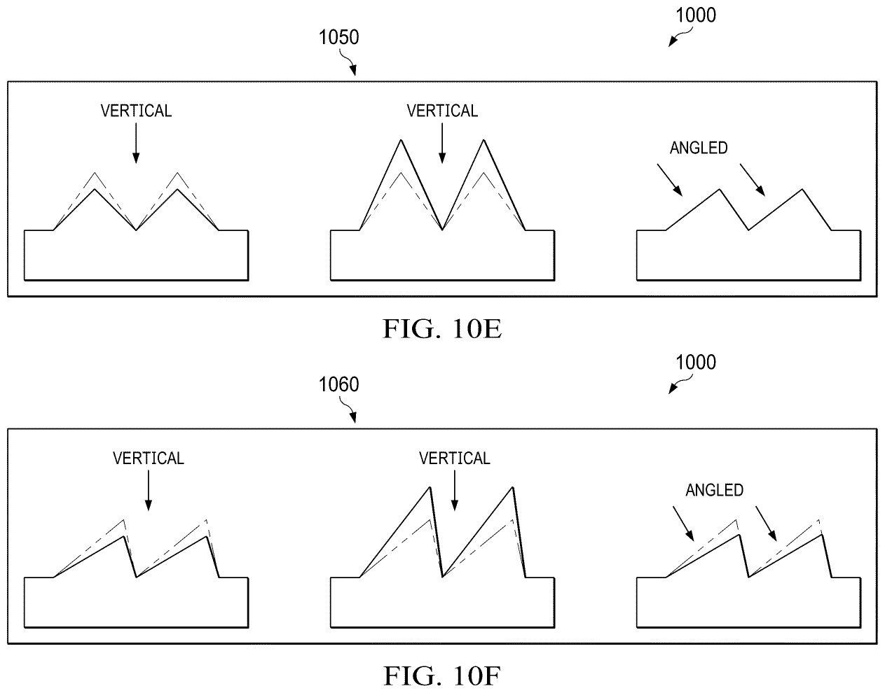

To further obtain a wider range of prism angle adjustment, another process 1000 for modifying the angle of the prism or other structures by plasma etching is illustrated in FIGS. 10A-F. This process starts at step 1010 with a replication of initial mold 902 on top of the substrate 904, as shown in FIG. 10A. The functional resin 906 can work as a hard mask material, or different mask material may be used between the functional resin 906 and the substrate 904. The pattern of the initial mold 902 is replicated at step 1020 by a micro-imprint process on the optical substrate 904 with the functional resin 906, as shown in FIG. 10B. At step 1030, the resin replica 1004 is demolded from the initial mold 902, as shown in FIG. 10C. At step 1040, a descum process is used to remove the blank resin 1002 between the prism feature of the resin replica 1004 and the optical substrate 904 (or hard mask layer), as shown in FIG. 10D. A dry etch process is applied afterward at step 1050, as shown in FIG. 10E. The prism shape will be finally transferred into substrate material. Depending on the etch selectivity between the hard mask material and the optical substrate 904, the prism side wall angle can be adjusted. Step 1050 starts with a symmetric prism array; if a vertical dry etch process is applied, the final prism in the optical substrate can have a larger or smaller prism angle if the etch ratio (between the optical substrate 904 and the functional resin 906) is larger or smaller than 1. The increase or decrease of both sides will be with the same ratio.

If an angled dry etch process (such as ion beam milling) is applied, such as the process illustrated in FIG. 10F at step 1060, one side of the prism will be modified more than another side such that the prism will become asymmetric, and the prism angles can be adjusted separately. In this process, the functional resin 906 serves as an etch sacrificial material. A hard mask layer (such as SiO2, SiN) can also be inserted between the functional resin 906 and the optical substrate 904 to further boost the tuning range.

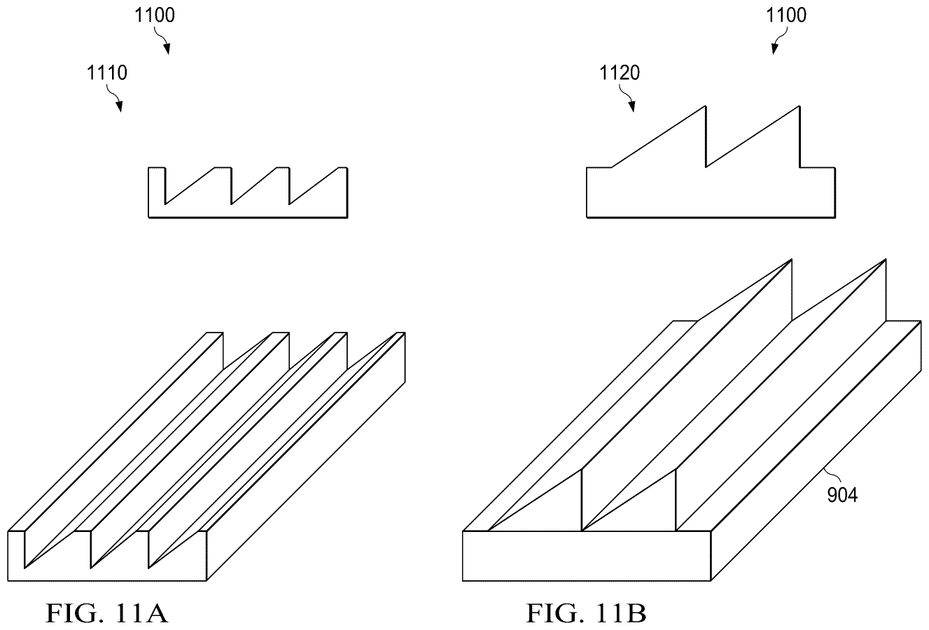

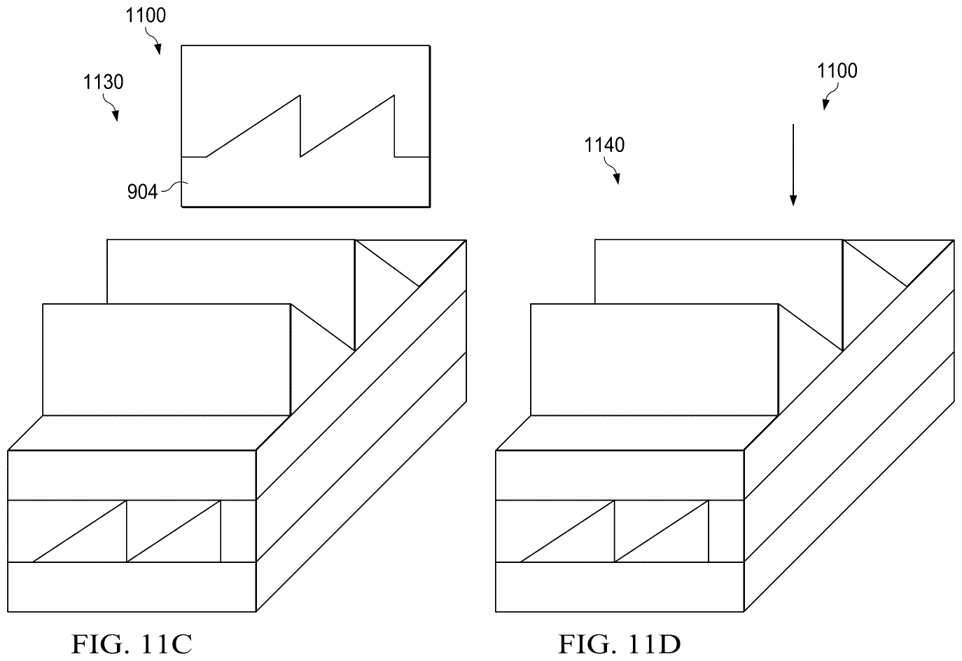

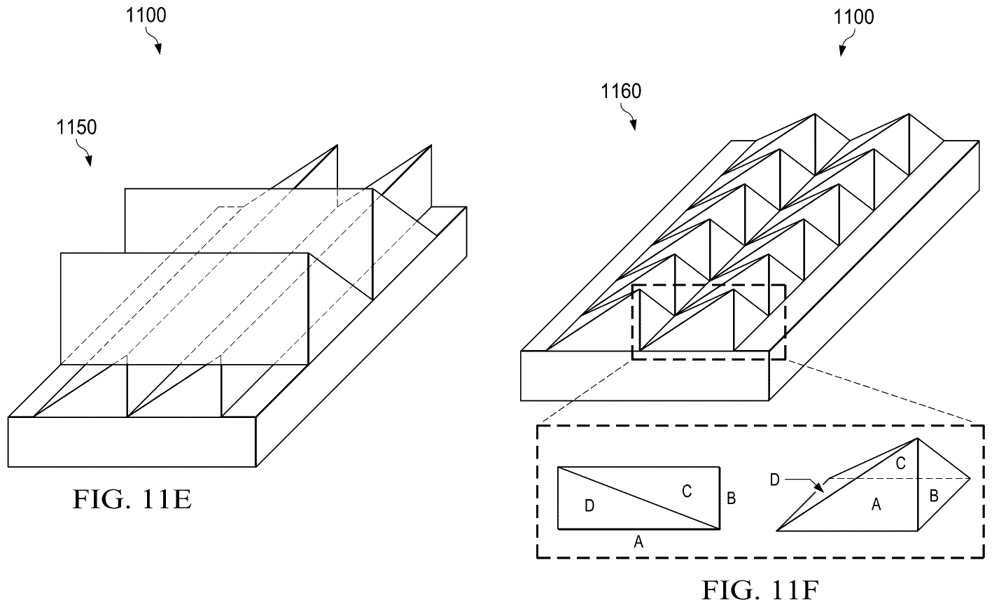

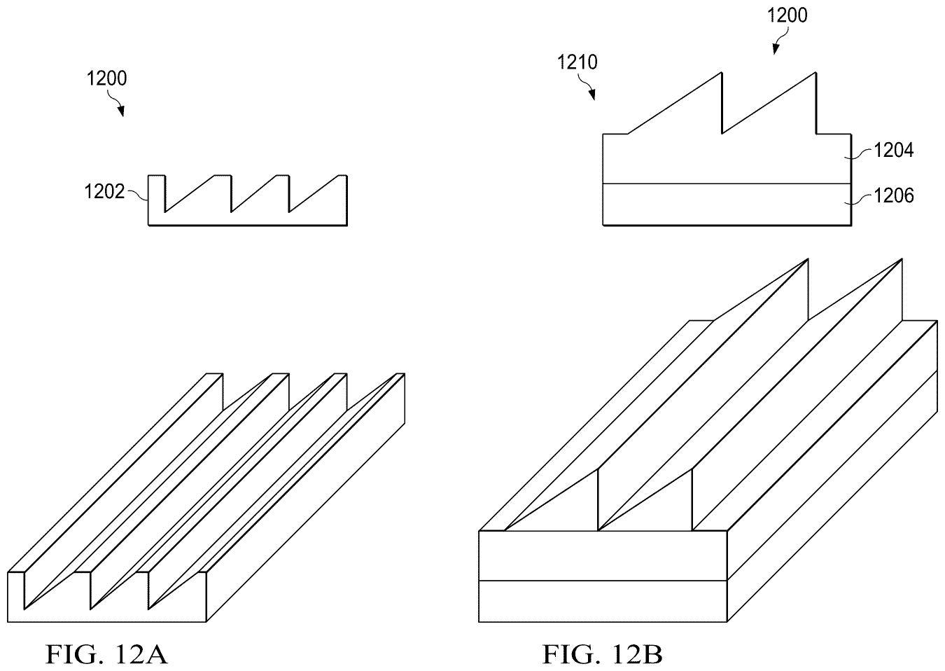

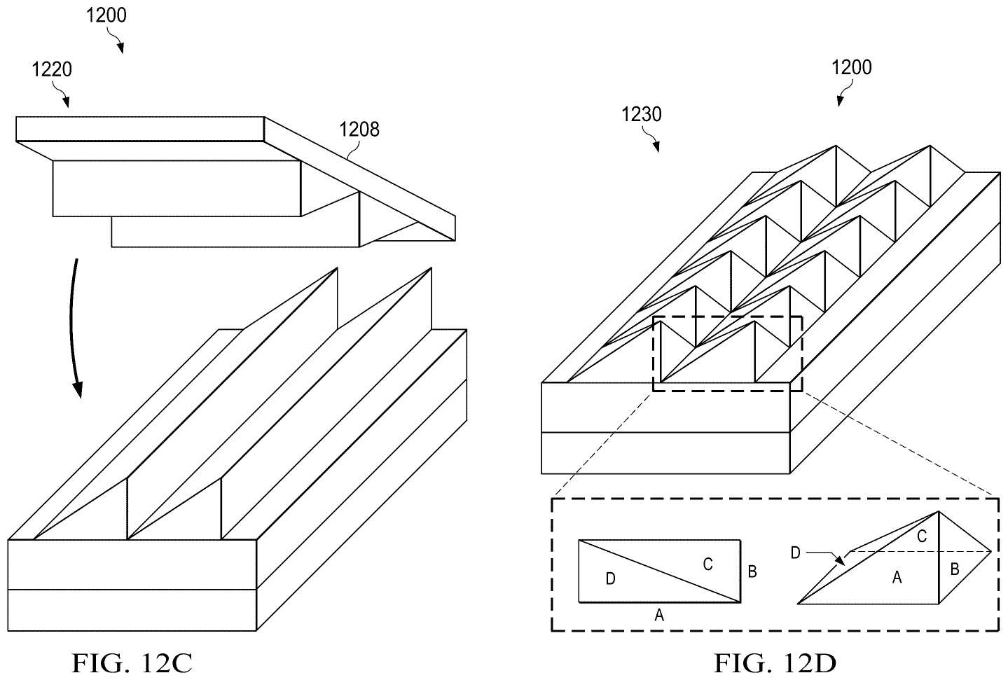

To reduce the reflective waveguide form factor, in some embodiments a two-dimensional (2D) structure array is used, e.g., to combine the functionality of the exit pupil expander and the output coupler. The 2D prism array is fabricated in some embodiments with a process 1100 as illustrated in FIGS. 11 and 12.

FIGS. 11A-F illustrate a double patterning and etch process 1100. The first set of prism array is etched into the optical substrate 904 at steps 1110, 1120 using a first prism array mold 902 fabricated in some embodiments as illustrated in FIGS. 5, 9, and 10. In other words, the first prism array mold 902 is used to pattern and etch the first set of prisms into the optical substrate 904. In some embodiments, a planarization layer is coated on the first prism array, after which a second prism array is micro-imprinted and etched into the first layer material at step 1130. After a planarization material strip at step 1140, a superimposed prism with hard mask material is formed at step 1150. The final prism array is the superimposing of two sets of prisms generated at step 1160 with a strip of the hard mask material. Each prism unit contains the prism sides of both one-dimensional (1D) prisms. There will be four reflective planes to be used in waveguide design. If the starting 1D prism has one side vertical to substrate, the final prism will have two working reflective planes. In the example illustrated at the top-down and side views of the callout at step 1160, faces B and D have the prism shape of the first prism array, and faces A and C have the prism shape of the second prism array. Faces A and B can be vertical to the substrate plane when both the first and second prism arrays have one side vertical to the substrate, resulting in a prism array with only two slope reflectors, which can benefit waveguide display performance.

FIGS. 12A-D illustrate a process flow for fabricating two-dimensional reflective structures using a double-imprint process 1200. FIG. 12A illustrates a first prism mold 1202 for patterning a first set of prisms. FIG. 12B illustrates patterning the functional resin 1204 on top of the optical substrate 1206 using the first prism mold 1202 by a soft imprint process at step 1210. The functional resin 1204 is partially cured such that it still holds the gel material property while maintaining the shape of the first set of prisms. At step 1220, illustrated in FIG. 12C, a mold 1208 of the second prism of the array is then imprinted on top of the first imprint. The resin is then hard cured in step 1230, illustrated in FIG. 12D. The final prism is the superimposing of two sets of prisms. Similar to FIG. 11F, in the example illustrated at the top-down and side views of the callout at step 1230, faces B and D have the prism shape of the first prism array, and faces A and C have the prism shape of the second prism array. Faces A and B can be vertical to the substrate plane when both the first and second prism arrays have one side vertical to the substrate, resulting in a prism array with only two slope reflectors, which can benefit waveguide display performance.

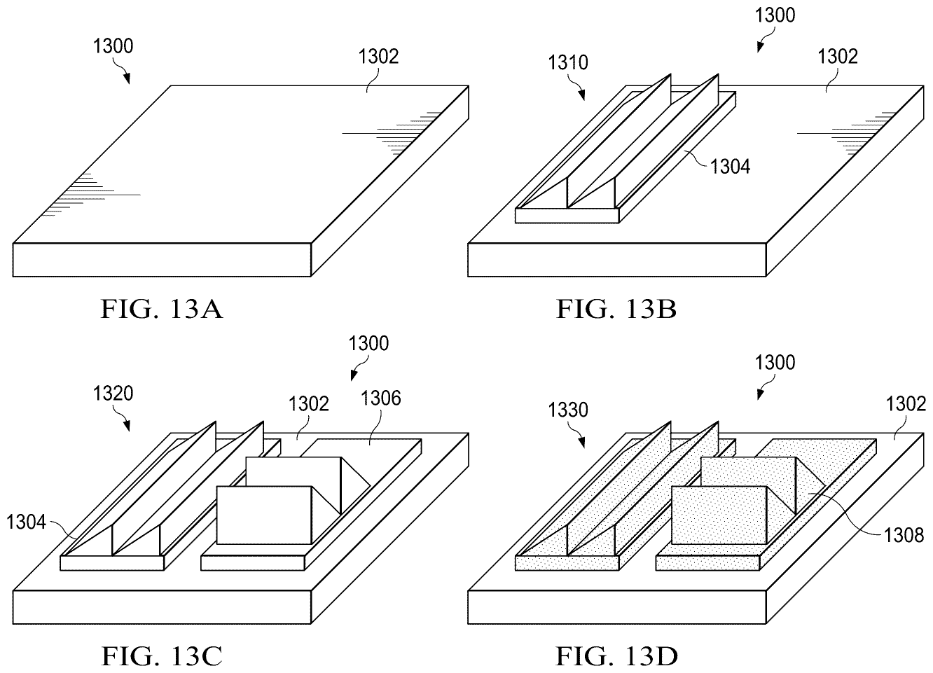

A functional reflective waveguide may incorporate different structures to be used for light input coupling, pupil expansion and pupil outcoupling (as described in, e.g., FIGS. 2 and 3). FIGS. 13A-D illustrate a process 1300 for integrating arrays having different structures together or, in some implementations, creating novel functionality by creating novel structures using multiple direct imprinting. With the various prism arrays fabricated as described above, a composite mold can be implemented. A composite mold consists of various areas, each of which incorporates a specific prism array. FIGS. 13A-D illustrate a process for fabricating a composite mold that involves micro-imprint and anti-sticking layer coating. The process begins with an optical substrate 1302, as shown in FIG. 13A. At step 1310, a first set of prisms 1304 is micro imprinted locally using a functional resin on the optical substrate 1302, as shown in FIG. 13B. In some embodiments, the functional resin is locally coated on the optical substrate 1302 by inkjet, spray coat, slot die or other local coating method. At step 1320, a second set of prisms 1306 is then imprinted using the functional resin with the same localized pattern scheme, as shown in FIG. 13C. A final working mold can be obtained at step 1330 with an anti-sticking layer coating 1308 on top of the two resin prism sets, as shown in FIG. 13D.

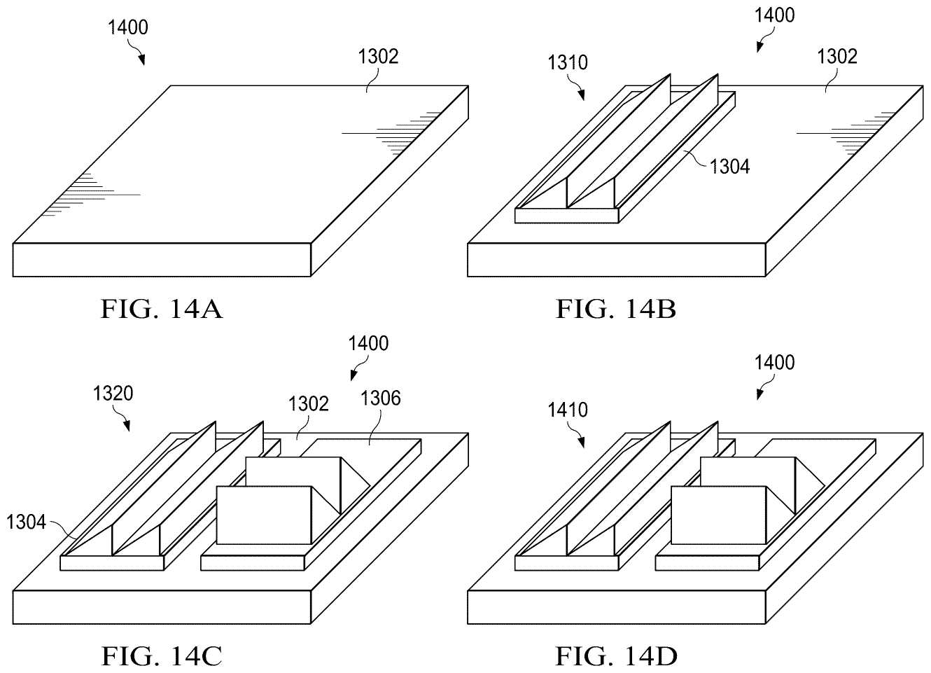

FIGS. 14A-D show a micro-imprint and etch process 1400 for fabricating a composite mold. As with the process illustrated in FIGS. 13A-D, the process begins with the optical substrate 1302, as shown in FIG. 14A, and steps 1310 and 1320, as shown in FIGS. 14B and 14C, respectively. Thus, similar to the process described with respect to FIGS. 13B and 13C, both sets of prisms 1304, 1306 are first patterned on top of the optical substrate 1302 by the above local pattern scheme. At step 1410, as shown in FIG. 14D, a dry etch process is followed to transfer the pattern into substrates. In some embodiments, a hard mask material is used in this process. As described above, the prism shape can be adjusted by various dry etch conditions.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
depositing a hard mask layer on a crystalline substrate;
lithographically patterning the hard mask layer to form a first pattern; and
anisotropically removing the crystalline substrate to form a prism array waveguide mold with the first pattern.

2. The method of claim 1, wherein
a crystal axis of the crystalline substrate defines periodic optical structures of the prism array.

3. The method of claim 2, further comprising:
adjusting a pitch and flat top width of a lithographic pattern for lithographically patterning the hard mask layer to define a height of the periodic optical structures of the prism array.

4. The method of claim 1, wherein
anisotropically removing the crystalline substrate is performed by wet chemical etching.

5. The method of claim 1, wherein
patterning the hard mask layer comprises lithography exposure, development, and pattern transfer from lithography resist to the hard mask layer.

6. The method of claim 1, further comprising:
replicating the first pattern of the prism array waveguide mold on an optical substrate with a functional resin to form a resin replica.

7. The method of claim 6, further comprising:
shrinking the resin replica to reduce a prism angle.

8. The method of claim 7, further comprising:
depositing an anti-sticking layer on the resin replica.

9. The method of claim 6, further comprising:
replicating a second pattern of a second prism array waveguide on the optical substrate with the functional resin to form a two-dimensional resin replica.

10. The method of claim 1, further comprising:
lithographically patterning the hard mask layer to form a second pattern; and
anisotropically removing the crystalline substrate to form a prism array waveguide mold comprising the first pattern and the second pattern.

11. A waveguide mold, comprising:
a prism array wherein a crystal axis of a crystalline substrate defines periodic optical structures of the prism array.

12. The waveguide mold of claim 11, wherein the prism array is formed by:
depositing a hard mask layer on the crystalline substrate;
lithographically patterning the hard mask layer; and
anisotropically removing the crystalline substrate.
